(19) United States
(12) Patent Application Publication
(10) Pub. No.: US 2026/0360846 A1
(43) Pub. Date: Nov. 12, 2026

(54) Pressure Control System and Pressure Control Method

(71) Applicant: Nissan Motor Co., Ltd., Yokohama-shi, Kanagawa (JP)

(72) Inventor: Tetsuya Aoki, Kanagawa (JP)

(21) Appl. No.: 19/121,713

(22) PCT Filed: Oct. 21, 2022
(86) PCT No.: PCT/IB2022/000601

§ 371 Date: Apr. 16, 2025

(51) Int. Cl. H01M 10/48; H01M 10/42

(52) U.S. Cl. CPC H01M 10/48; H01M 10/4235

(57) ABSTRACT

A pressure control system for controlling pressure applied to a battery module has a plurality of battery cells each having a solid electrolyte and a negative electrode containing lithium. The pressure control system includes: a movable end plate configured to apply pressure to the battery module by pressing the battery module along a stacking direction of the battery cells; and a controller configured to adjust a value of the pressure by controlling the movable end plate; wherein in a case in which a battery control system that controls the charging/discharging of the battery module is shut down, the controller reduces the pressure to a predetermined pressure, after which the battery control system is shut down.

### TECHNICAL FIELD

The present invention relates to a pressure control system and a pressure control method.

### BACKGROUND

A lithium-ion secondary battery is known that includes an electrode body having a positive electrode and a negative electrode containing a Si-containing negative electrode active material, and a surface pressure control unit that controls the surface pressure applied to the electrode body in a predetermined direction (see, for example, JP 2019-61749 A). The surface pressure control unit of this lithium-ion secondary battery controls a fluctuation range of the surface pressure that fluctuates with charging/discharging to 3.8 MPa or less. Specifically, this fluctuation range is the difference between the maximum value and minimum value of the surface pressure observed when performing charging/discharging from 0% to 100% SOC, and is determined from the resistance increase ratio before and after a charging/discharging cycle of the lithium-ion secondary battery (see, for example, JP 2019-61749 A (paragraphs [0014] and [0108] to [0114])).

### SUMMARY

In conventional technology, the fluctuation range of the surface pressure is determined by a resistance increase ratio between the resistance before the start of a charging/discharging cycle and the resistance after the charging/discharging cycle has ended; however, no consideration is given to the deterioration of a secondary battery when shut down and left and not charged or discharged, which is thought to have a large impact on an in-vehicle secondary battery, nor is consideration given to deterioration that does not appear in the resistance value of the secondary battery.

Generally, the downtime of a vehicle is longer than the time that the vehicle is in operation, so the vehicle-mounted secondary battery is left in a pressurized state for long periods of time without charging/discharging being performed. In this case, particularly, a negative electrode including Li has a relatively low rigidity, and thus creep tends to occur in the negative electrode. There is a problem that, although the amount of creep per unit time is very small, in a case in which this creep accumulates over a long period of time, the creep may have an adverse effect on the secondary battery.

A problem to be solved by the present invention is to provide a pressure control system and a pressure control method that can reduce the amount of creep that occurs in a negative electrode.

The present invention solves the above problem by, in a case of shutting down a battery control system that controls charging/discharging of a battery module, shutting down the battery control system after reducing pressure applied to the battery module to a predetermined pressure.

With the present invention, the amount of creep that occurs in a negative electrode can be reduced.

### BRIEF DESCRIPTION OF THE DRAWINGS

FIG. 1 is a block diagram illustrating a battery control system according to an embodiment of the present invention;

FIG. 2 is a flowchart showing a procedure of a pressure control method when the battery control system according to the embodiment of the present invention is shut down;

FIG. 3 is a graph showing a relationship among pressure applied to a battery cell, an amount of creep of a negative electrode, and a resistance value of the battery cell;.

FIG. 4 is an explanatory figure of creep that occurs in the negative electrode;

FIG. 5 is a graph showing change over time in pressure and resistance value in the pressure control method when it is determined in step S6 of FIG. 2 that Tₑₓ>Tₜₕ; and

FIG. 6 is a graph showing change over time in pressure and resistance value in the pressure control method when it is determined in step S6 of FIG. 2 that Tₑₓ≤Tₜₕ.

### DETAILED DESCRIPTION

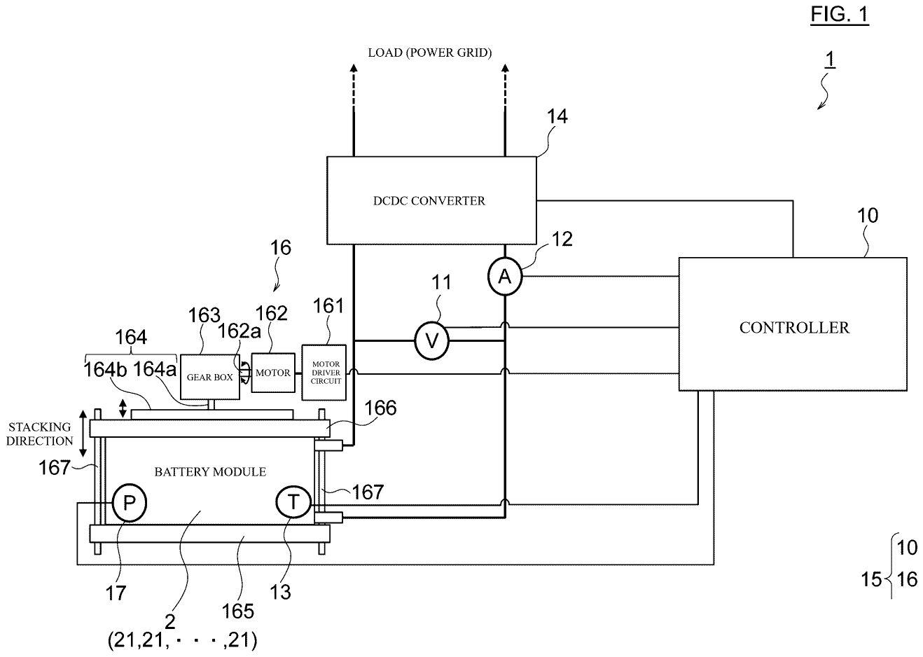

Hereinafter, an embodiment of the present invention will be described with reference to the drawings. FIG. 1 is a block diagram illustrating a battery control system 1 according to the present embodiment.

As illustrated in FIG. 1, the battery control system 1 includes a controller 10, a voltage sensor 11, a current sensor 12, a temperature sensor 13, a DCDC converter 14, a pressure application mechanism 16, and a pressure sensor 17.

In the present embodiment, the controller 10, the pressure application mechanism 16, and the pressure sensor 17 are elements that constitute a pressure control system 15. Therefore, the controller 10 in the present embodiment corresponds to an example of “control means”, “downtime estimation means”, and “SOC estimation means” in the present invention. In addition, the temperature sensor 13 in the present embodiment corresponds to an example of “temperature acquiring means” in the present invention.

The controller 10 is a battery control unit (BCU). The controller 10 is composed of, for example, a memory such as a ROM or a RAM, and a processor such as a CPU. The controller 10 manages the state of a battery module 2 based on a detected voltage detected by the voltage sensor 11, a detected current detected by the current sensor 12, a detected temperature detected by the temperature sensor 13, and the like, and determines the SOC usage range of the battery module 2 according to the state of the battery module 2.

In addition, the controller 10 controls the pressure application mechanism 16 of the pressure control system 15. The controller 10, by controlling the pressure application mechanism 16, adjusts the value of the pressure applied to the battery module 2.

The controller 10 also estimates the downtime (expected downtime value Tₑₓ) from when the battery control system 1 is shut down until it is restarted.

The voltage sensor 11 is a sensor for detecting the voltage between terminals of the battery module 2. The voltage sensor 11 is connected between wiring connected to a positive electrode and a negative electrode of the battery module 2. The current sensor 12 is a sensor for detecting an input/output current of the battery module 2. The current sensor 12 is connected to the wiring that is connected to the positive electrode or the negative electrode of the battery module 2. The temperature sensor 13 is provided in the battery module 2. The temperature sensor 13 is a sensor for detecting a temperature of the battery module 2.

The DCDC converter 14 is a power conversion device that converts the voltage input from the battery module 2 into a predetermined voltage and outputs power to a load such as a motor. The DCDC converter 14 also functions as a power conversion device that converts a voltage input from a load such as a motor or a charging device into a predetermined voltage and outputs power to the battery module 2. The DCDC converter 14 is controlled by the controller 10. The battery module 2 is connected to an input side of the DCDC converter 14, and a load is connected to an output side of the DCDC converter 14. The load may be a power grid including a motor inverter or the like. That is, the battery module 2 is connected to the load via the DCDC converter 14.

The pressure application mechanism 16 applies pressure to the battery module 2 by pressing the battery module 2 along the stacking direction of battery cells 21 in the battery module 2. The pressure application mechanism 16 in the present embodiment includes a motor driver circuit 161, a motor 162, a gear box 163, a pressure transmission body 164, a fixed end plate 165, a movable end plate 166, and a plurality of shafts 167. The movable end plate 166 in the present embodiment corresponds to an example of “pressure application means” in the present invention.

The motor driver circuit 161 operates the motor 162. The motor driver circuit 161 controls driving of the operation of the motor 162 based on a control signal from the controller 10.

The motor 162 has a first drive shaft 162a. The motor 162 drives and rotates the first drive shaft 162a in response to an output from the motor driver circuit 161.

The gear box 163 is connected to the first drive shaft 162a, and converts rotational drive of the first drive shaft 162a into drive of the pressure transmission body 164 in the above-described stacking direction.

The pressure transmission body 164 moves up and down by the driving force transmitted via the gear box 163. The pressure transmission body 164 includes a second drive shaft 164a and a pressure transmission plate 164b. The second drive shaft 164a is connected to the gear box 163, and receives the rotational drive of the first drive shaft 162a of the motor 162 from the gear box 163. The pressure transmission plate 164b is a plate that moves along the stacking direction as the second drive shaft 164a rotates, and in the present embodiment, the pressure applied to the battery module 2 can be controlled to increase by the pressure transmission plate 164b moving downward in the figure, and the pressure applied to the battery module 2 can be controlled to decrease by the pressure transmission plate 164b moving upward in the figure.

The fixed end plate 165 and the movable end plate 166 are a pair of plate-like members and are connected to each other by the plurality of shafts 167. The fixed end plate 165 is fixed to the shafts 167 and supports the battery module 2. On the other hand, the movable end plate 166 is not fixed to the shafts 167 and is movable along the extension direction of the shafts 167, and applies pressure to the battery module 2 from above in response to the force transmitted from the pressure transmission body 164. In addition, the movable end plate 166 can move along the stacking direction in response to expansion and contraction of the battery module 2 due to charging/discharging, and in response to expansion and contraction of the battery module 2 due to changes in the pressure applied to the battery module 2 by the movable end plate 166.

The pressure sensor 17 is a sensor capable of measuring the pressure applied to the battery module 2. The pressure sensor 17 can output the detected pressure to the controller 10.

The battery module 2 is electrically connected to a charging device. The charging device connected to the battery cells 21 is, for example, a device for charging the battery module 2 mounted in an electric vehicle or a hybrid vehicle. Charging of the battery module 2 mounted in the vehicle is performed by removing a charging cable from a charging device, attaching a charging gun at the end of the charging cable to a connector of a charging port of the vehicle, and then operating a charging start switch. The controller 10 manages a state of charge (SOC) of the battery cells 21 included in the battery module 2, and controls the DCDC converter 14 and the charging device so that the state of charge of the battery module 2 becomes a target state of charge.

As described above, the battery module 2 is electrically connected to a load such as a motor. The load is a device that operates using the power of the battery module 2, and is, for example, a motor that serves as a drive source for the vehicle, and an auxiliary device such as an air conditioner and lights. The discharge of the battery module 2 is carried out under the control of the controller 10 in response to a system request or an external power request. The system request corresponds to a command from an on-board computer such as an ECU while the vehicle is running. Regarding an external power request, for example, in a case in which an air conditioner is operated by a timer setting in response to a command from an external device such as a mobile terminal before the vehicle starts to travel so that the interior temperature of the vehicle cabin is appropriate when the vehicle starts to travel, the command from the external device corresponds to an external power request.

In addition, the battery module 2 mounted in an electric vehicle or a hybrid vehicle may be used for Vehicle Grid Integration (VGI). VGI is a technology in which an electric vehicle or a hybrid vehicle equipped with a battery module 2 is connected to a system line, and the power stored in the battery module 2 is supplied to a system line (load) via the power grid.

The battery cells 21 included in the battery module 2 have at least a positive electrode, a solid electrolyte, and a negative electrode. The positive electrode contains at least a positive electrode active material capable of releasing and absorbing an alkali metal such as lithium (Li), sodium (Na), or potassium (K), and although not particularly limited, it is preferable that the positive electrode contains a positive electrode active material that includes sulfur. As the solid electrolyte, for example, a sulfide solid electrolyte, an oxide solid electrolyte, or the like can be used; however, it is preferable to use a sulfide solid electrolyte. The negative electrode may be made of any material that includes lithium, and preferably includes lithium metal, for example.

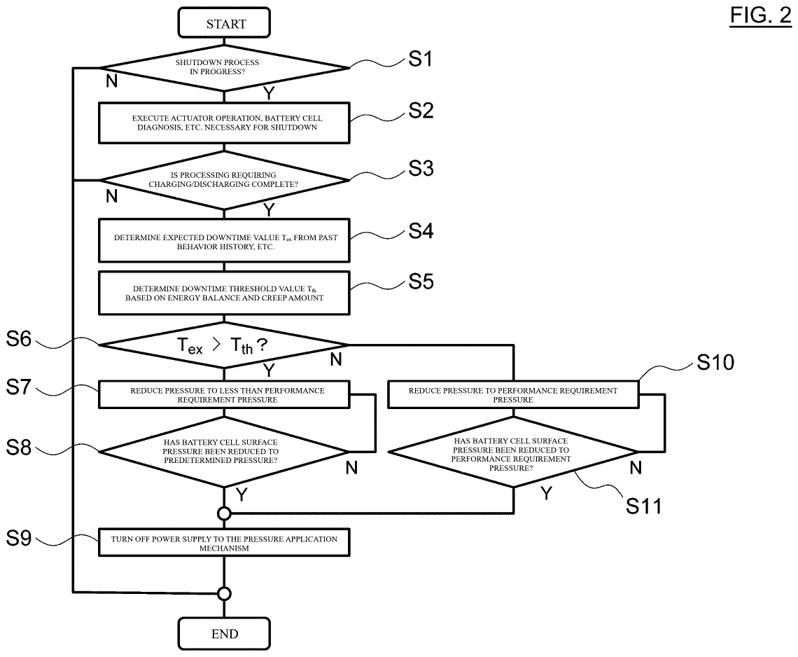

In the following, a pressure control method for the battery module 2 using the pressure control system 15 included in the battery control system 1 will be described. FIG. 2 is a flowchart showing a procedure of the pressure control method when the battery control system of the present embodiment is shut down. The pressure control method shown in FIG. 2 is repeatedly executed at predetermined intervals before the battery control system 1 is shut down, that is, when the vehicle is shut down.

In this control method, first, in step S1, the controller 10 determines whether or not the vehicle is in the process of being shut down. Generally, in the shutdown process of the vehicle, when an occupant turns OFF the vehicle's ignition switch, an instruction is sent to each control system installed in the vehicle (specifically, the battery control system 1, a drive motor control system, a steering control system, and the like) to start the shutdown process of each system.

In a case in which the controller 10 determines that each control system installed in the vehicle is in progress of a shutdown process, in step S2, the controller 10 controls the battery module 2 and the DCDC converter 14 to perform power supply to the actuator operations included in the vehicle shutdown process, self-diagnosis of the battery module 2 performed by the battery control system 1, and the like. Note that one example of the actuator operation includes an actuator operation performed by the drive motor control system to return a stepping motor (drive motor) to an initial position. In step S2, the process of shutting down the vehicle consuming electric power is completed, except for the control process performed by the controller 10 of the battery control system 1 in step S3 and thereafter.

Note that in a case in which the controller 10 determines in step S1 that the vehicle is not in the progress of a shutdown process, the current pressure control is terminated, and the pressure control is restarted from step S1 after a predetermined period.

In step S3, the controller 10 determines whether or not the shutdown process (excluding the control process performed by the controller 10 in and after step S3) that requires charging/discharging has been completed in the vehicle.

In a case in which the controller 10 determines in step S3 that the process requiring charging/discharging has been completed in the vehicle, then in step S4, the controller 10 determines the expected downtime value Tₑₓ by using the vehicle's past behavior history, map information, SOC, and the like individually or in combination. Note that in a case in which the controller 10 determines in step S3 that the process requiring charging/discharging has not been completed in the vehicle, the controller 10 ends the current pressure control, and restarts the pressure control from step S1 after a predetermined period.

The past behavior history is, for example, a history of the time the vehicle was shut down and left for each time period. The controller 10 can predict the expected downtime value Tₑₓ at the current time from the history of the time the vehicle was shut down and left for each past time period. In addition, the controller 10 can predict the expected downtime value Tₑₓ at the current position from position information on a map and history of the shutdown and left time at a specific position on the map in the past. For example, in a case in which it is determined that the current location is work, home, or the like, in a case in which it is determined that the current time falls within a time period when an occupant is at work, at home, or the like, or in other such cases, the controller 10 predicts that the shutdown and left time will be relatively long. On the other hand, for example, in a case in which it is determined that the current location is a convenience store or the like, the controller 10 predicts that the shutdown and left time will be relatively short. Alternatively, the controller 10 can predict the expected downtime value Tₑₓ at the current SOC from the history of the past shutdown and left time of the battery module 2 for each SOC. Note that the SOC can be estimated by a general method using an open circuit voltage and an integrated value of the charging/discharging charge of each battery cell 21.

Next, in step S5, the controller 10 determines a downtime threshold value Tₜₕ. The downtime threshold value Tₜₕ is a threshold value that serves as a criterion for determining whether or not to reduce the pressure in the battery module 2 to below the performance requirement pressure P₁, as will be described later. In a case in which the expected downtime value Tex exceeds the downtime threshold value Tₜₕ, in the post-process, the controller 10 reduces the pressure in the battery module 2 to below the performance requirement pressure P₁. Note that the downtime threshold value Tₜₕ in the present embodiment corresponds to an example of a “predetermined time” in the present invention.

The downtime threshold value Tₜₕ (for example, about 5 to 10 minutes) is determined based on an energy balance between an amount of power consumed by the pressure application mechanism 16 due to the operation of reducing the pressure on the battery module 2 and the amount of discharged power due to self-discharge of the battery module 2 per unit time under the current pressure, and an amount of deformation of the negative electrode due to creep per unit time under the current pressure. For example, in a case in which the time when the shutdown and left time is short, the power consumption due to the operation of the motor of the pressure application mechanism 16, or the like may be greater than the amount of power that can be saved by suppressing self-discharge. In addition, in a case in which the shutdown and left time is short, it is believed that creep hardly occurs at all. Therefore, the downtime threshold value Tₜₕ is set shorter, for example, as the energy balance is better (as the amount of discharged power due to self-discharge is greater than the amount of power consumed by the pressure application mechanism 16) and as the amount of deformation of the above-described negative electrode is greater. The energy balance and the deformation of the negative electrode described above can be calculated in advance by experiment, and the downtime threshold value Tₜₕ is set to a time at which the benefits of suppressing self-discharge and creep are sufficiently obtained relative to the amount of power consumed by the pressure application mechanism 16.

In addition, the amount of creep increases as the temperature increases, and thus the amount of deformation of the negative electrode increases as the temperature of the battery module 2 increases. Therefore, the controller 10 in the present embodiment shortens the downtime threshold value Tₜₕ as the temperature of the battery module 2 detected by the temperature sensor 13 increases. As a result, even in a case in which the temperature of the battery module 2 is high and the deformation of the negative electrode due to creep can be large, the pressure applied to the battery module 2 in subsequent processing can be reduced to suppress deformation of the negative electrode.

In addition, the higher the SOC, the thicker the negative electrode becomes, and thus the greater the effect of creep in the negative electrode becomes. Therefore, the deformation amount D of the negative electrode increases as the SOC of the battery module 2 increases. In contrast, the controller 10 in the present embodiment shortens the downtime threshold value Tₜₕ as the SOC estimated by the controller 10 based on the temperature of the battery module 2 becomes higher. As a result, even in a case in which the SOC of the battery module 2 is high and the deformation of the negative electrode due to creep can be large, the pressure applied to the battery module 2 in the subsequent processing can be reduced to suppress deformation of the negative electrode.

In step S6, the controller 10 determines whether or not the expected downtime value Tₑₓ is longer than the downtime threshold value Tₜₕ.

In a case in which, in step S6, the controller 10 determines that the expected downtime value Tₑₓ is longer than the downtime threshold value Tₜₕ, in step S7, the controller 10 moves the movable end plate 166 of the pressure application mechanism 16 upward to reduce the pressure applied to the battery module 2 to a predetermined pressure. Note that the pressure applied to the battery cells 21 is approximately equal to the pressure applied to the battery module 2.

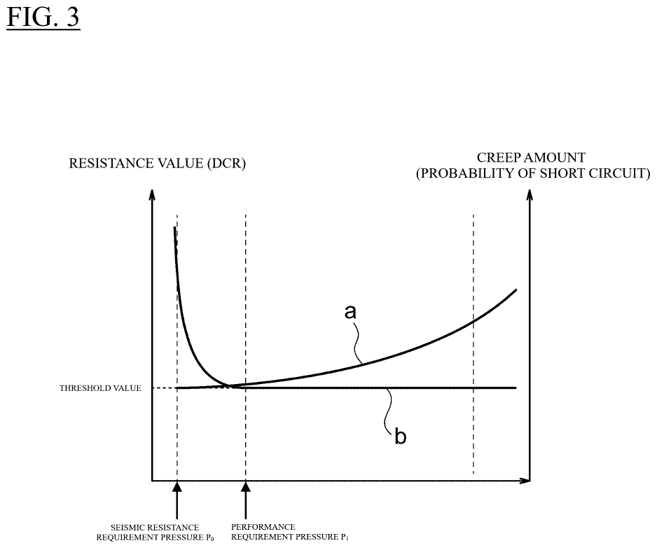

FIG. 3 is a graph showing a relationship between pressure applied to the battery cells 21 and a resistance value and amount of creep of the negative electrodes of the battery cells 21. In FIG. 3, curve a indicates the amount of creep. As shown by curve a in FIG. 3, the greater the pressure applied to the battery module 2, the greater the amount of creep in the negative electrodes of the battery cells 21.

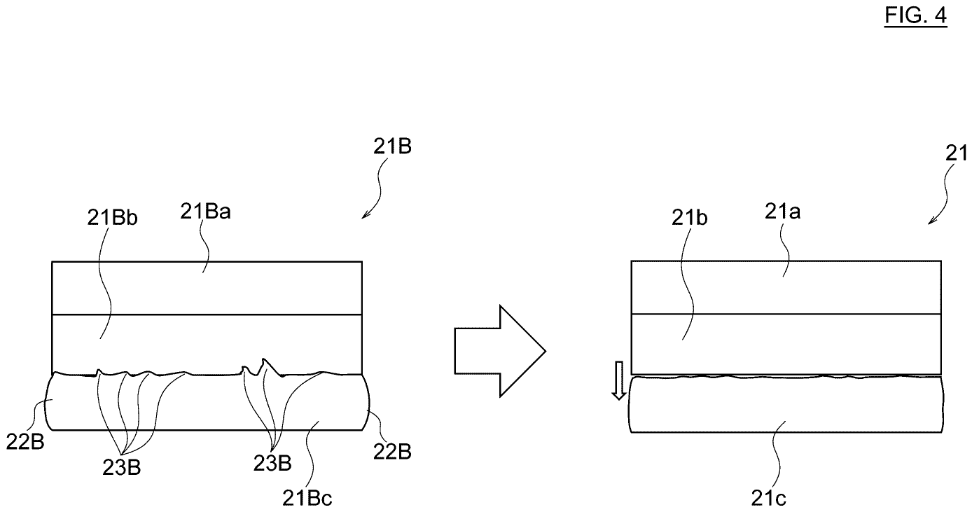

FIG. 4 is an explanatory figure of creep that occurs in a negative electrode. The left figure in FIG. 4 shows a battery cell 21B that has been shut down and left without reducing the pressure applied to the battery module, and the right figure in FIG. 4 shows a battery cell 21 that has been shut down and left after the pressure applied to the battery module 2 has been reduced.

As shown in the left figure of FIG. 4, in a case in which the pressure applied to the battery module is not reduced, a negative electrode 21Bc is compressed in the thickness direction by the pressure and extends in the width direction. As a result, extending portions 22B that extend outward are formed on side portions of the negative electrode 21Bc. Since the extending portions 22B do not face a positive electrode 21Ba, and since it is difficult for the extending portions 22B to contribute to charging/discharging, the battery performance deteriorates. In addition, the pressure causes protruding portions 23B that protrude toward the positive electrode 21Ba and a solid electrolyte 21Bb to occur. The protruding portions 23B are closer to the positive electrode 21Ba and current is more likely to concentrate thereon, which increases the possibility of short-circuiting the positive electrode 21Ba and the negative electrode 21Bc.

On the other hand, in the present embodiment, by reducing the pressure applied to the battery module, deformation due to creep of the negative electrode 21c is suppressed, and thus, as shown in the right figure of FIG. 4, the extending portions 22B and the protruding portions 23B protruding toward the positive electrode 21a and the solid electrolyte 21b are less likely to occur in the negative electrode 21c. This makes it possible to suppress deterioration of battery performance and the occurrence of short circuits.

Returning to FIG. 2, in step S8, the controller 10 determines, based on the detection value of the pressure sensor 17, whether or not the pressure applied to the battery module 2 has reached a predetermined pressure. The predetermined pressure in the present embodiment is lower than the performance requirement pressure P₁ and higher than the seismic resistance requirement pressure P₀. Note that the predetermined pressure may be a pressure higher than the performance requirement pressure P₁.

As shown in FIG. 3, the seismic resistance requirement pressure P₀ in the present embodiment is the minimum pressure required for maintaining contact between the movable end plate 166 and the battery module 2. In the present embodiment, this is the minimum pressure at which the battery module 2 will not fall out from between the fixed end plate 165 and the movable end plate 166 even if an external force due to impact, vibration, or the like is applied to the battery module 2. By setting the pressure to be greater than the seismic resistance requirement pressure P₀, it is possible to prevent the battery module 2 from falling out.

As shown in FIG. 3, when the pressure applied to the battery module 2 becomes lower than the performance requirement pressure P₁, the resistance value of the battery cells 21 increases. This is believed to be because, as shown in the right figure of FIG. 4, the pressure of the negative electrode 21c against the solid electrolyte 21b decreases, resulting in a smaller contact area between the two. On the other hand, when the pressure becomes higher than the performance requirement pressure P₁, a certain contact area or more is obtained between the negative electrode 21c and the solid electrolyte 21b, and thus the resistance value is maintained at a substantially constant low resistance value.

The performance requirement pressure P₁ is the pressure at which the electrical resistance of the battery cells 21 becomes equal to a predetermined threshold value, and this threshold value is the maximum value of electrical resistance within the range of electrical resistance at which the battery cells 21 can input and output the charging/discharging power required for operating the control system of the vehicle. The performance requirement pressure P₁ is greater than the seismic resistance requirement pressure P₀.

In this way, in step S7, by setting the pressure to be below the performance requirement pressure P₁, the resistance value is set to a high state, and thus even if the battery module 2 is shut down and left for a long period of time, the amount of self-discharge of the battery module 2 while it is shut down and left can be reduced.

Such a performance requirement pressure P₁ can be experimentally obtained as follows. The higher the resistance of the battery cells, the less power the battery cells can charge and discharge, and thus pressure is applied to the battery cells to lower the resistance until the battery cells can output at least the power required to operate the control system of the vehicle. In this case, it is possible to determine the performance requirement pressure P₁ by experimentally determining, based on a relationship between pressure and power, the minimum pressure at which the power required for operating the control system can be output.

In addition, in the present embodiment, the pressure applied to the battery module 2 (the pressure applied to the battery cells 21) is detected by the pressure sensor 17, however, this is not limited to this. The pressure may be estimated without the use of the pressure sensor 17.

More specifically, for example, in a case in which the negative electrode is a Li metal negative electrode, the thickness of the battery cells changes approximately in proportion to the SOC. Therefore, the thickness of the battery module changes approximately in proportion to the charging/discharging amount of the battery module. Furthermore, the amount of change in thickness of the battery module caused by operating the motor is determined by the gear ratio, screw pitch, and the like within the pressure application mechanism, and the amount of operation of the motor. Therefore, in a case in which the relationship between the difference between the amount of change in thickness of the battery module due to charging/discharging amount and the amount of change in thickness of the battery module due to motor operation and the pressure is experimentally obtained, the pressure can be estimated from time-series changes in the motor command value and the SOC, based on this relationship.

Returning to FIG. 2, in a case in which it is determined in step S8 that the pressure applied to the battery module 2 has reached the predetermined pressure, the controller 10 turns OFF the power supply to the pressure application mechanism 16 in step S9. In other words, the pressure control by the pressure control system 15 is terminated. Note that even when the power supply to the pressure application mechanism 16 is turned OFF, the pressure is maintained at the predetermined pressure. In this manner, in step S9, the controller 10 shuts down the battery control system 1 after completing the pressure control.

Note that in a case in which it is determined in step S8 that the pressure applied to the battery module 2 has not reached the predetermined pressure, the process returns to step S7, and the pressure application mechanism 16 is controlled to reduce the pressure again.

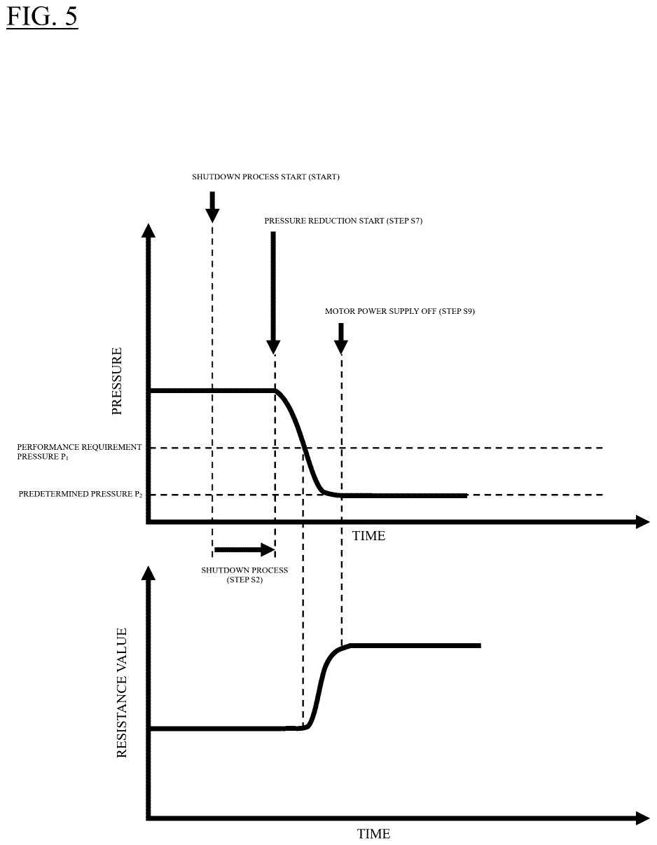

FIG. 5 is a graph showing the change over time in pressure and resistance value in the pressure control method when it is determined in step S6 of FIG. 2 that Tₑₓ>Tₜₕ. The upper diagram in FIG. 5 is a graph showing the change in pressure over time, and the lower graph in FIG. 5 is a graph showing the change in resistance value over time.

As shown in the upper diagram of FIG. 5, from the start to step S6 of the flowchart shown in FIG. 2, the pressure is maintained at a pressure higher than the performance requirement pressure P₁. At this time, although charging/discharging is performed during the shutdown process, the resistance value of the battery cells 21 is maintained approximately constant, as shown in the lower diagram of FIG. 5.

Next, after the controller 10 determines in step S6 that Tₑₓ>Tₜₕ, the controller 10 starts reducing the pressure in step S7. As the pressure decreases, the resistance value of the battery cells 21 increases, as shown in the lower diagram of FIG. 5. This pressure reduction operation continues until the pressure reaches a predetermined pressure P₂.

Next, in step S9, the power supply to the motor 162 of the pressure application mechanism 16 is turned OFF, and then the battery control system 1 is shut down. As a result, the pressure reduction operation is completed, and the pressure is maintained at the predetermined pressure P₂ that is lower than the performance requirement pressure P₁.

In this way, in a case in which the battery control system 1 is shut down, the pressure applied to the battery module 2 is increased to at least the performance requirement pressure P₁ the next time the battery control system 1 is started again. This makes it possible to prevent a shortage of power required to operate the battery control system 1.

Returning to FIG. 2, in a case in which it is determined in step S6 that Tₑₓ≤Tₜₕ, in step S10, the controller 10 of the present embodiment reduces the pressure to the performance requirement pressure P₁ that is greater than the predetermined pressure. That is, in step S10, it is determined that the shutdown and left time is short, and thus the pressure is reduced within a range in which the resistance value at which the battery control system 1 and the like can operate is maintained. As a result, in a case in which the shutdown and left time is short, it is possible to suppress the occurrence of creep while suppressing power consumption due to the operation of the pressure application mechanism 16.

Next, in step S11, the controller 10 determines whether or not the pressure has reached the performance requirement pressure P₁.

In a case in which the controller 10 determines that the pressure has reached the performance requirement pressure P₁, the controller 10 turns OFF the power supply to the pressure application mechanism 16 in step S9. In other words, the pressure control by the pressure control system 15 is terminated. Note that even when the power supply to the pressure application mechanism 16 is turned OFF, the pressure is maintained at the performance requirement pressure P₁. In this manner, in step S9, the controller 10 shuts down the battery control system 1 after completing the pressure control. In this way, in a case in which the occupant repeatedly starts and stops the vehicle within a short period of time, an increase in power consumption can be suppressed by not lowering the pressure below the performance requirement pressure P₁.

Note that in a case in which it is determined in step S11 that the pressure has not reached the performance requirement pressure P₁, the process returns to step S10, and the pressure application mechanism 16 is controlled to reduce the pressure again.

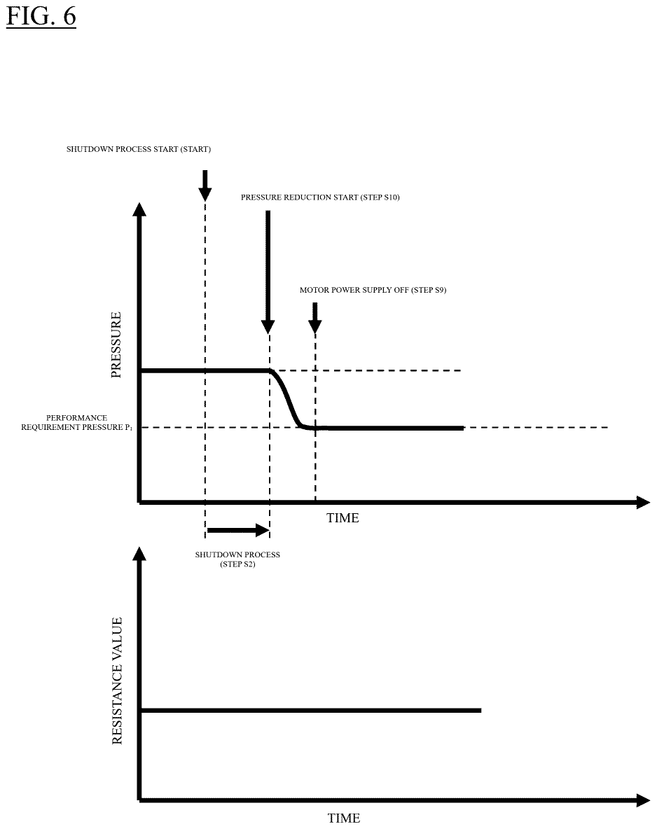

FIG. 6 is a graph showing the change over time in pressure and resistance value in the pressure control method when it is determined in step S6 of FIG. 2 that Tₑₓ≤Tₜₕ. The upper diagram in FIG. 6 is a graph showing the change in pressure over time, and the lower diagram in FIG. 6 is a graph showing the change in resistance value over time.

As shown in the upper diagram of FIG. 6, from the start to step S6 of the flowchart shown in FIG. 2, the pressure is maintained at a pressure higher than the performance requirement pressure P₁. At this time, as shown in the lower diagram of FIG. 6, although charging/discharging are performed during the shutdown process, the resistance value of the battery cells 21 is maintained approximately constant.

Next, after the controller 10 determines in step S6 that Tₑₓ≤Tₜₕ, the controller 10 starts reducing the pressure in step S10. Here, the pressure is within a range equal to or greater than the performance requirement pressure P₁, and thus the resistance value of the battery cells 21 is maintained approximately constant, as shown in the lower diagram of FIG. 6.

Next, after it is determined in step S11 that the pressure has reached the performance requirement pressure P₁, the motor 162 of the pressure application mechanism 16 is turned OFF in step S9. As a result, the pressure reduction operation is completed, and, as shown in the upper diagram of FIG. 6, the pressure is maintained at the performance requirement pressure P₁ that is greater than the predetermined pressure P₂. In addition, the resistance value is maintained approximately constant, as shown in the lower diagram of FIG. 6.

In this way, in a case in which it is determined that the shutdown and left time is short, the benefits of suppressing self-discharge and suppressing deformation of the negative electrode due to creep are small. In other words, there is a possibility that the power consumption due to the operation of the pressure application mechanism 16 will be greater than the amount of power saved by suppressing self-discharge, and thus there is no need to reduce the pressure below the performance requirement pressure P₁. Therefore, an increase in power consumption due to the operation of the pressure application mechanism 16 can be suppressed.

Note that in the present embodiment, the controller 10 reduces the pressure to the performance requirement pressure P₁ in step S10; however, the controller 10 may reduce the pressure to a pressure higher than the performance requirement pressure P₁ in step S10. Furthermore, in the present embodiment, the controller 10 reduces the pressure in step S10; however, the controller 10 may maintain the pressure without reducing the pressure in step S10. As a result, no power consumption occurs due to the operation of the pressure application mechanism 16. However, the actual downtime may be longer than the expected downtime value Tₑₓ predicted by the controller 10, and thus if the pressure is lowered to a range equal to or higher than the performance requirement pressure P₁ in preparation for such a case, the effect of suppressing the occurrence of creep can be obtained.

Conventionally, when a vehicle was shut down and left, pressure equal to or higher than the performance requirement pressure was applied to the battery module, which made it easy for creep to occur in the negative electrodes of the battery cells, and the creep caused deterioration of battery performance and increased the probability of a short circuit. In contrast, in the present embodiment, when the vehicle is shut down and left, the pressure is reduced to below the performance requirement pressure P₁, thereby suppressing the occurrence of creep and suppressing deterioration of battery performance and an increase in the probability of short circuiting.

In addition, conventionally, when a vehicle was shut down and left, pressure equal to or higher than the performance requirement pressure was applied to the battery module, which kept the resistance value of the battery module low and increased the amount of self-discharge. In contrast, in the embodiment, when the vehicle is shut down and left, the pressure is reduced to below the performance requirement pressure P₁ and the resistance value is increased, so that the amount of self-discharge can be reduced.

### DESCRIPTION OF REFERENCE NUMERALS

1 Battery control system
10 Controller
11 Voltage sensor
12 Current sensor
13 Temperature sensor
14 DCDC converter
15 Discharge means
16 Pressure application mechanism
161 Motor driver circuit
162 Motor
162a First drive shaft 163 Gear box
164 Pressure transmission body
164a Second drive shaft
164b Pressure transmission plate
165 Fixed end plate
166 Movable end plate
167 Shaft
17 Pressure sensor
2 Battery module
21 Battery cell
21a Positive electrode
21b Solid electrolyte
21c Negative electrode

1. A pressure control system for controlling a pressure applied to a battery module in which battery cells each having a solid electrolyte and a negative electrode containing lithium are stacked, the pressure control system comprising:
pressure application means configured to apply pressure to the battery module by pressing the battery module along a stacking direction of the battery cells;
control means configured to adjust a value of the pressure by controlling the pressure application means; and
downtime estimation means configured to estimate a downtime from when a battery control system that controls charging/discharging of the battery module is shut down until when the battery control system is restarted; wherein
when the battery control system is shut down, if the downtime estimated by the downtime estimation means is longer than a predetermined time, the battery control system is shut down after the control means reduces the pressure to a predetermined pressure,
when the battery control system is shut down, if the downtime estimated by the downtime estimation means is equal to or shorter than a predetermined time, the battery control system is shut down after the control means maintains the pressure or reduces the pressure to a pressure greater than the predetermined pressure.

2. The pressure control system according to claim 1, wherein
the predetermined pressure is greater than a seismic resistance requirement pressure, and
the seismic resistance requirement pressure is a minimum pressure required to maintain contact between the pressure application means and the battery module.

3. (canceled)

4. The pressure control system according to claim 1, further comprising temperature acquiring means configured to measure or estimate a temperature of the battery module, wherein the downtime estimation means sets the predetermined time to be shorter as the temperature of the battery module increases.

5. The pressure control system according to claim 1, further comprising SOC estimation means configured to estimate an SOC of the battery cells, wherein the downtime estimation means sets the predetermined time to be shorter as the SOC of the battery cells increases.

6. The pressure control system according to claim 1, wherein
the predetermined pressure is lower than a performance requirement pressure;
the performance requirement pressure is a pressure at which an electrical resistance of the battery cells becomes equal to a threshold value; and
the threshold value is a maximum value of the electrical resistance within a range of electrical resistance of the battery cells that allows the battery cells to input and output charge/discharge power required to operate a vehicle control system.

7. The pressure control system according to claim 6, wherein the control means increases the pressure to at least the performance requirement pressure when the battery control system is restarted after being shut down.

8. A pressure control method for controlling a pressure applied to a battery module in which battery cells each having a solid electrolyte and a negative electrode containing lithium are stacked, comprising:
when a battery control system that controls charging/discharging of the battery module is shut down, estimating a downtime from when the battery control system is shut down until when the battery control system is restarted;
if the downtime estimated is longer than a predetermined time, shutting down the battery control system after the pressure is reduced to a predetermined pressure; and
if the downtime estimated is equal to or shorter than a predetermined time, shutting down the battery control system after maintaining the pressure or reducing the pressure to a pressure greater than the predetermined pressure.
